(19) United States
(12) Patent Application Publication
(10) Pub. No.: US 2014/0012651 A1
(43) Pub. Date: Jan. 9, 2014

(54) EARNING REWARDS VIA BILL PAYMENT

(71) Applicants: Carrie Anne Hanson, Charlotte, NC (US); Scott R. Enscoe, Charlotte, NC (US); Alexander C. Wittkowski, Charlotte, NC (US); David M. Grigg, Rock Hill, SC (US); Daniel David, Charlotte, NC (US); Katherine Dintenfass, Charlotte, NC (US); Brett Newman, Burlingame, CA (US); Leo Kopelow, San Francisco, CA (US); Yameng Li, Berkeley, CA (US); Nicole Chen, San Fransico, CA (US); Nicholas Sharp, San Fransico, CA (US)

(72) Inventors: Carrie Anne Hanson, Charlotte, NC (US); Scott R. Enscoe, Charlotte, NC (US); Alexander C. Wittkowski, Charlotte, NC (US); David M. Grigg, Rock Hill, SC (US); Daniel David, Charlotte, NC (US); Katherine Dintenfass, Charlotte, NC (US); Brett Newman, Burlingame, CA (US); Leo Kopelow, San Francisco, CA (US); Yameng Li, Berkeley, CA (US); Nicole Chen, San Fransico, CA (US); Nicholas Sharp, San Fransico, CA (US)

(73) Assignee: BANK OF AMERICA CORPORATION, Charlotte, NC (US)

(21) Appl. No.: 13/543,651

(22) Filed: Jul. 6, 2012

(51) Int. Cl. G06Q 30/02

(52) U.S. Cl. 705/14.27

(57) ABSTRACT

Embodiments of the invention are directed to systems, methods and computer program products associated with a bill payment feature that enables users to receive rewards for paying bills before their due dates. In some embodiments, a method comprises determining a bill due within a predetermined period in the future; initiating, via a mobile network, notification of the bill, an amount associated with the bill, and a due date associated with the bill; initiating, via the mobile network, a first option to pay the bill prior to the due date; and in response to determining the first option is selected: deducting, from an account, an amount of funds corresponding to the amount associated with the bill; providing a reward to the account; and transmitting, on the due date, the amount of funds to a merchant associated with the bill.

### BACKGROUND

A person may pay a bill earlier than the due date so that the funds to pay the bill can be accounted for and the bill payment task can be checked off a to-do list. There is a need to reward such a person.

### BRIEF SUMMARY

Embodiments of the invention are directed to systems, methods and computer program products for paying a bill. In some embodiments, an apparatus is provided for paying a bill. The apparatus comprises: a memory; a processor; and a module stored in the memory, executable by the processor, and configured to: determine a bill due within a predetermined period in the future; initiate, via a mobile network, notification of the bill, an amount associated with the bill, and a due date associated with the bill; initiate, via the mobile network, a first option to pay the bill prior to the due date; and in response to determining the first option is selected: deduct, from an account, an amount of funds corresponding to the amount associated with the bill; provide a reward to the account; and transmit, on the due date, the amount of funds to a merchant associated with the bill.

In some embodiments, in response to determining the first option is selected, the module is further configured to: move the amount of funds to a holding account not associated with a user of the account.

In some embodiments, in response to determining the first option is selected, the module is further configured to: initiate presentation of information associated with the reward.

In some embodiments, the reward is associated with a number of reward points, and the number of reward points is based on the amount associated with the bill and an amount of time between receiving selection of the first option and the due date associated with the bill.

In some embodiments, a predetermined number of reward points are associated with a reward level, and the module is further configured to: determine a first reward level achieved by the account based on the number of reward points achieved by the account; and initiate presentation of a number of reward points required to achieve a second reward level higher than the first reward level achieved by the account.

In some embodiments, the module is further configured to: initiate pictorial representation of the first reward level achieved by the account; and initiate pictorial representation of a number of reward points required to achieve the second reward level.

In some embodiments, the module is further configured to: initiate a second option to pay the bill on a due date associated with the bill, wherein an amount of funds corresponding the amount associated with the bill is deducted from the account on the due date; and in response to determining the second option is selected, transmit, on the due date, the amount associated with the bill to a merchant associated with the bill.

In some embodiments, the module is further configured to: initiate a third option to dismiss the notification of the bill.

In some embodiments, when the third option is selected, the module is further configured to: initiate periodic notification of the bill.

In some embodiments, the module is further configured to: initiate presentation of an account balance associated with the account.

In some embodiments, the module is further configured to: initiate presentation of a duration of time between a current date and the due date.

In some embodiments, the bill is determined based on previous bill payments made using funds associated with the account.

In some embodiments, the bill is determined based on manual input.

In some embodiments, the bill is determined based on an established electronic link between the account and the merchant.

In some embodiments, the bill is at least one of a recurring or non-recurring bill.

In some embodiments, the bill is at least one of an interest-accruing or non-interest-accruing bill.

In some embodiments, the amount associated with the bill is at least one of automatically populated or manually input by a user.

In some embodiments, the account comprises a financial institution account.

In some embodiments, a method for paying a bill comprises: determining a bill due within a predetermined period in the future; initiating, via a mobile network, notification of the bill, an amount associated with the bill, and a due date associated with the bill; initiating, via the mobile network, a first option to pay the bill prior to the due date; and in response to determining the first option is selected: deducting, from an account, an amount of funds corresponding to the amount associated with the bill; providing a reward to the account; and transmitting, on the due date, the amount of funds to a merchant associated with the bill.

In some embodiments, a computer program product for paying a bill comprises a non-transitory computer-readable medium comprising a set of codes for causing a computer to: determine a bill due within a predetermined period in the future; initiate, via a mobile network, notification of the bill, an amount associated with the bill, and a due date associated with the bill; initiate, via the mobile network, a first option to pay the bill prior to the due date; and in response to determining the first option is selected: deduct, from an account, an amount of funds corresponding to the amount associated with the bill; provide a reward to the account; and transmit, on the due date, the amount of funds to a merchant associated with the bill.

### BRIEF DESCRIPTION OF THE DRAWINGS

Having thus described embodiments of the invention in general terms, reference will now be made to the accompanying drawings, where:

FIG. 1 is a flowchart illustrating a general process flow for paying a bill, in accordance with embodiments of the present invention;

FIG. 2 is a user interface presenting options to pay a bill, in accordance with embodiments of the present invention;

FIG. 3 is another user interface, in accordance with embodiments of the present invention; and

FIG. 4 is a block diagram illustrating technical components of a system for paying a bill, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Some people manually manage bill payment due dates, rather than setting up automatic bill payments, because they want to be in control of when funds are deducted from their account. In order to manually manage bill payment dates, people rely on self-designed bill reminder systems such as marking bills on a calendar or using other physical reminders. When people pay bills manually, they usually end up paying bills early. Embodiments of the invention are directed to providing rewards to users who pay bills early.

The invention addresses perceived accuracy limitations of account management and/or bill payment via a mobile device. Additionally, the invention reduces service calls from users requesting help in managing issues associated with account management and/or bill payment. The invention also helps to increase mobile adoption of services provided by a financial institution and reduces the cost associated with account management and/or bill payment to both the user and the financial institution.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, etc. The account is associated with and/or maintained by the entity. In other embodiments, an entity may not be a financial institution. In still other embodiments, the entity may be the merchant itself (e.g., the merchant that transmits a bill to the user).

In some embodiments, the “user” may be a customer (e.g., an account holder or a person who has an account (e.g., banking account, credit account, etc.) at the entity) or potential customer (e.g., a person who has submitted an application for an account, a person who is the target of marketing materials that are distributed by the entity, a person who applies for a loan that not yet been funded).

As used herein, a mobile device may be any portable mobile communication or computing device. As used herein, a user interface is a user interface associated with a mobile device. As used herein, a mobile network may be any network (e.g., data network, communication network, etc.) via which the mobile device connects to a financial institution account or to the future account view feature or service associated with the financial institution account. The network may be a local area network (LAN), a wide area network (WAN), and/or a global area network (GAN), such as the Internet. The network may be secure and/or unsecure and may also include wireless and/or wireline and/or optical interconnection technology.

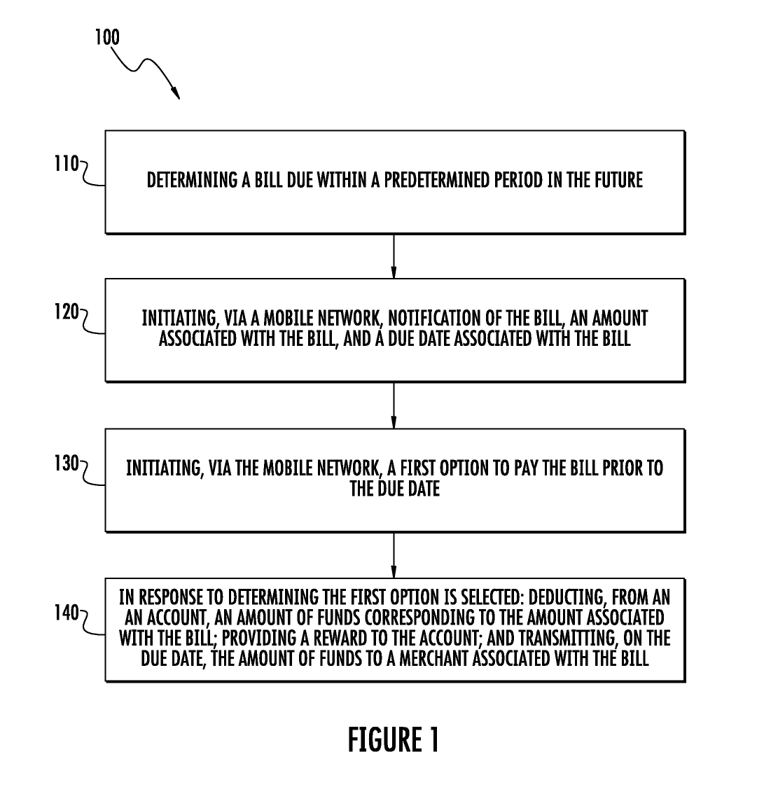

Referring now to FIG. 1, a general process flow 100 is provided for paying a bill. At block 110, the method comprises determining a bill due within a predetermined period in the future. At block 120, the method comprises initiating, via a mobile network, notification of the bill, an amount associated with the bill, and a due date associated with the bill. At block 130, the method comprises initiating, via the mobile network, a first option to pay the bill prior to the due date. At block 140, the method comprises in response to determining the first option is selected: deducting, from an account, an amount of funds corresponding to the amount associated with the bill; providing a reward to the account; and transmitting, on the due date, the amount of funds to a merchant associated with the bill.

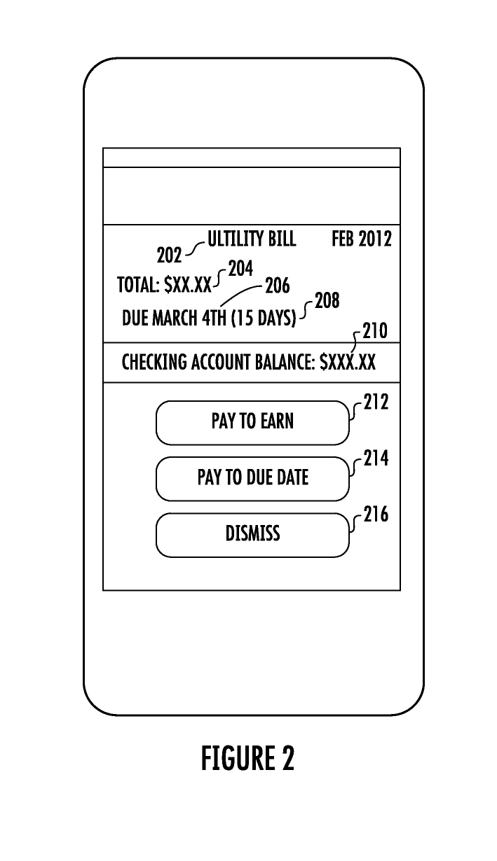

Referring now to FIG. 2, illustrated is a user interface for paying a bill, in accordance with embodiments of the present invention. The bill is at least one of a recurring or non-recurring bill. Additionally, the bill is at least one of an interest-accruing or non-interest-accruing bill. In some embodiments, a user authenticates into a financial institution account in order to access a bill payment service. When the user accesses this service, the system initiates graphical presentation of a user interface as indicated in FIG. 2. The user interface presents information associated with a bill (e.g., the bill with the earliest due date from a plurality of bills) that is due within a predetermined period in the future. The information includes the name 202 of the bill, the amount 204 of the bill, the due date 206 of the bill, and the amount of time 208 between the present date and the due date of the bill. Additionally, the user interface presents an account balance 210 associated with an account from which funds will be used to pay the bill.

In some embodiments, the bill payment notification may be generated based on historical bill payments associated with the account (e.g., bill payments during the preceding six months). Additionally or alternatively, in some embodiments, the bill payment notification may be manually scheduled by a user (e.g., the user schedules a bill payment notification for the nineteenth of every month). Additionally or alternatively, the bill payment notification may be based on a bill payment invoice that is electronically received into the account from a merchant source (e.g., a utilities company). Therefore, the user may have configured the account such that the user's account is electronically linked to the user's utilities account such that when the merchant issues the bill, the bill is automatically transmitted to the user's account. When the bill is automatically received at the user's account, the amount 204 of the bill is automatically populated. In instances where the bill payment notification is manually scheduled by the user, the amount 204 of the bill may need to manually input by the user.

The user interface presents three options to pay the bill. The first option 212 (“Pay to Earn”) is an option to pay the bill prior to the due date. The second option 214 is to pay the bill on the due date. The third option 216 is to dismiss notification of the bill. When the user selects the first option, the system immediately deducts, from the account, an amount of funds corresponding to the amount associated with the bill. The amount of funds are moved to a holding account not associated with the account holder. The system transmits the amount associated with the bill to the merchant associated with the bill on or about the due date of the bill. Additionally, the system provides a reward to the account. The reward may be provided on the day the first option is selected, which may be the same day that the amount of funds corresponding to the amount of the bill is deducted from the account. Alternatively or additionally, the reward may be provided on the day the bill is paid (i.e., on or near the due date of the bill). In some embodiments, a reward is provided on both days (i.e., the day when the first option is selected and the day when the bill payment is made). It should be noted that rewards may be different for different types of bills paid. For example, it may be necessary to provide more rewards to a customer that utilizes the “pay to earn” option for an interest-accruing bill compared to a non-interest-accruing bill as the customer would receive a benefit (i.e., less charged interest) if an interest-accruing bill were paid earlier than the due date.

When the user selects the second option 214 (“Pay on Due Date”) to pay the bill on a due date associated with the bill, an amount of funds corresponding to the bill amount is deducted from the account on the due date. Additionally, the system transmits the bill amount to a merchant associated with the bill on the due date. When the user selects the third option 216 (“Dismiss”) to dismiss notification of the bill, the system may continue to notify the user regarding the bill at predetermined intervals in the future until the user selects an option to pay the bill.

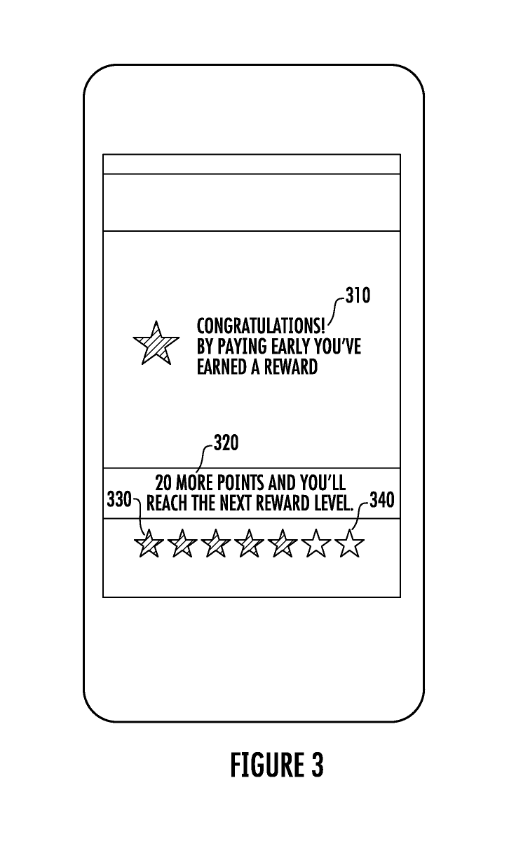

FIG. 3 presents another user interface in accordance with embodiments of the invention. When the user selects the first option 212 in FIG. 2, the user is transported to another user interface. FIG. 3 presents this other user interface. The user interface presents information 310 associated with the reward. For example, the reward may comprise a number of reward points. The amount of reward points awarded to the account is proportional to at least one of the amount associated with the bill or an amount of time between receiving selection of the first option and the due date associated with the bill. In some embodiments, the financial institution may establish reward levels, wherein an account achieves reward points in order to progress through reward levels. For example, when an account earns ten points within a predetermined period of time (e.g., two months), the account progresses to a first reward level. Subsequently, when the account earns another twenty points within a predetermined period of time (e.g., three months), the account progresses to a second reward level. Therefore, each reward level may be associated with a different number of reward points and different predetermined periods of time within which the reward points need to be achieved. Additionally, in some embodiments, a reward level achieved by a first account may be higher than a reward level achieved by a second account when both accounts achieve the same number of reward points. Additionally, in some embodiments, a number of reward points achieved by a first account may be different from a number of reward points achieved by a second account when both accounts pay a bill associated with the same characteristics (e.g., same bill amount, same number of days until payment due date, etc.).

As indicated in FIG. 3, the user interface presents the current reward level 330 associated with the account. Also as indicted in FIG. 3, the user interface indicates how many additional reward points 320, 340 need to be achieved by the account in order to progress through to the next reward level. In some embodiments, the reward levels and reward points either achieved by the account or required to be achieved by the account to achieve a higher reward level are presented both via words (e.g., 320) and via pictorial representations (e.g., 340).

In some embodiments, it may be advantageous to offer the ability for a merchant to receive funds earlier for customers who have selected the “pay to earn” option and funds have already been deducted from the customer's account and held in a non-customer account. In some embodiments, it may be advantageous to provide data/information to the merchant, such as a number of customers or amounts of funds committed to the merchant under the “pay to earn” program.

In some embodiments, the customer may be provided with increased rewards for utilizing one account over another account to pay the bill. In some embodiments, a customer may receive increased rewards for utilizing a credit account. In some embodiments, an opportunity to “sweep” accounts to maximize benefits may be provided. For example, a customer may receive increased rewards for utilizing one account and then immediately (or soon thereafter) replenish the funds (or pay a credit account) on the account utilized with another account.

In some embodiments, the bill that is transmitted to the user (either a physical bill or electronic bill) comprises readable indicia (e.g., Quick Response (QR) code, barcode, radio frequency identification (RFID) tag, near field communication (NFC) tag, etc.). When the readable indicia (e.g., RFID tag, NFC tag, etc.) is scanned by the mobile device or when an image of the readable indicia (e.g., QR code, barcode, etc.) is captured by the mobile device, information regarding the bill may be loaded and/or processed by the mobile device. This information includes the bill name, bill identification number, merchant associated with the bill, bill due date, bill payment options, bill amount, past due amount, previous overpayments, etc. The mobile device may add the bill to the various user interfaces described herein either with or without user confirmation.

The mobile device may also communicate information to the merchant either directly from the mobile device via a network, or via a system (e.g., external server) associated with the financial institution. The mobile device may send information to the merchant regarding the user's handling of the bill. For example, the mobile device may send a message to the merchant when the user views a bill associated with the merchant on the user's mobile device. Additionally, the mobile device may send a message to the merchant when the user selects an option to pay the bill.

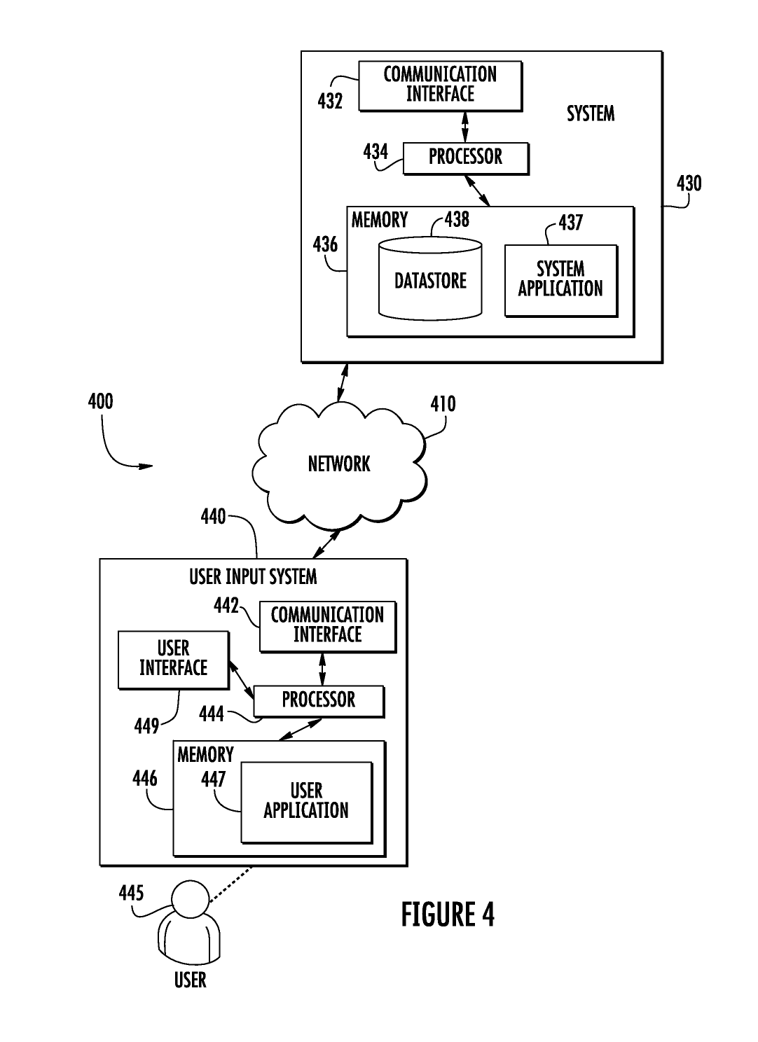

Referring now to FIG. 4, FIG. 4 presents an exemplary block diagram of the system environment 400 for implementing the process flow 100 described in FIG. 1, in accordance with embodiments of the present invention. As illustrated, the system environment 400 includes a network 410, a system 430, and a user input system 440. Also shown in FIG. 4 is a user 445 of the user input system 440. The user input system 440 may be a mobile device described herein. The user 445 may be a person who uses the user input system 440 to execute a user application 447. The user application 447 may be an application to access a financial institution account or a bill payment service associated with the financial institution account. The bill payment service or capability incorporates the features described herein. For example, the bill payment service enables presentation of the user interfaces described previously. The user application 447 and/or the system application 437 may incorporate one or more parts of the process flow 100.

As shown in FIG. 4, the system 430, and the user input system 440 are each operatively and selectively connected to the network 410, which may include one or more separate networks. In addition, the network 410 may include a local area network (LAN), a wide area network (WAN), and/or a global area network (GAN), such as the Internet. It will also be understood that the network 410 may be secure and/or unsecure and may also include wireless and/or wireline and/or optical interconnection technology.

The user input system 440 may include any computerized apparatus that can be configured to perform any one or more of the functions of the user input system 440 described and/or contemplated herein. For example, the user 445 may use the user input system 440 to transmit and/or receive information or commands to and from the system 430. In some embodiments, for example, the user input system 440 may include a personal computer system, a mobile computing device, a personal digital assistant, a mobile phone, a network device, and/or the like. As illustrated in FIG. 4, in accordance with some embodiments of the present invention, the user input system 440 includes a communication interface 442, a processor 444, a memory 446 having an user application 444 stored therein, and a user interface 449. In such embodiments, the communication interface 442 is operatively and selectively connected to the processor 444, which is operatively and selectively connected to the user interface 449 and the memory 446. In some embodiments, the user 445 may use the user application 447 to execute processes described with respect to the process flows described herein.

Each communication interface described herein, including the communication interface 442, generally includes hardware, and, in some instances, software, that enables the user input system 440, to transport, send, receive, and/or otherwise communicate information to and/or from the communication interface of one or more other systems on the network 410. For example, the communication interface 442 of the user input system 440 may include a wireless transceiver, modem, server, electrical connection, and/or other electronic device that operatively connects the user input system 440 to another system such as the system 430. The wireless transceiver may include a radio circuit to enable wireless transmission and reception of information.

Each processor described herein, including the processor 444, generally includes circuitry for implementing the audio, visual, and/or logic functions of the user input system 440. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 447 of the memory 446 of the user input system 440.

Each memory device described herein, including the memory 446 for storing the user application 447 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 4, the memory 446 includes the user application 447. In some embodiments, the user application 447 includes an interface for communicating with, navigating, controlling, configuring, and/or using the user input system 440. In some embodiments, the user application 447 includes computer-executable program code portions for instructing the processor 444 to perform one or more of the functions of the user application 447 described and/or contemplated herein. In some embodiments, the user application 447 may include and/or use one or more network and/or system communication protocols.

Also shown in FIG. 4 is the user interface 449. In some embodiments, the user interface 449 includes one or more output devices, such as a display and/or speaker, for presenting information to the user 445. In some embodiments, the user interface 449 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 445. In some embodiments, the user interface 449 includes the input and display devices of a mobile device, which are operable to receive and display information.

FIG. 4 also illustrates a system 430, in accordance with an embodiment of the present invention. The system 430 may include any computerized apparatus that can be configured to perform any one or more of the functions of the system 430 described and/or contemplated herein. In accordance with some embodiments, for example, the system 430 may include a computer network, an engine, a platform, a server, a database system, a front end system, a back end system, a personal computer system, and/or the like. Therefore, the system 430 may be a server managed by the financial institution. In some embodiments, such as the one illustrated in FIG. 4, the system 430 includes a communication interface 432, a processor 434, and a memory 436, which includes a system application 437 and a datastore 438 stored therein. As shown, the communication interface 432 is operatively and selectively connected to the processor 434, which is operatively and selectively connected to the memory 436.

It will be understood that the system application 437 may be configured to implement any one or more portions of the various user interfaces and/or process flow described herein. The system application 437 may interact with the user application 447. It will also be understood that, in some embodiments, the memory includes other applications. It will also be understood that, in some embodiments, the system application 437 is configured to communicate with the datastore 438, the user input system 440, etc.

It will be further understood that, in some embodiments, the system application 437 includes computer-executable program code portions for instructing the processor 434 to perform any one or more of the functions of the system application 437 described and/or contemplated herein. In some embodiments, the system application 437 may include and/or use one or more network and/or system communication protocols.

In addition to the system application 437, the memory 436 also includes the datastore 738. As used herein, the datastore 438 may be one or more distinct and/or remote datastores. In some embodiments, the datastore 438 is not located within the system and is instead located remotely from the system. In some embodiments, the datastore 438 stores information or data described herein. For example, the datastore 438 may store information associated with the user's financial institution account, bills, due dates associated with bills, etc.

It will be understood that the datastore 438 may include any one or more storage devices, including, but not limited to, datastores, databases, and/or any of the other storage devices typically associated with a computer system. It will also be understood that the datastore 438 may store information in any known way, such as, for example, by using one or more computer codes and/or languages, alphanumeric character strings, data sets, figures, tables, charts, links, documents, and/or the like. Further, in some embodiments, the datastore 438 may include information associated with one or more applications, such as, for example, the system application 437. It will also be understood that, in some embodiments, the datastore 438 provides a substantially real-time representation of the information stored therein, so that, for example, when the processor 434 accesses the datastore 438, the information stored therein is current or substantially current.

It will be understood that the embodiment of the system environment illustrated in FIG. 4 is exemplary and that other embodiments may vary. As another example, in some embodiments, the system 430 includes more, less, or different components. As another example, in some embodiments, some or all of the portions of the system environment 400 may be combined into a single portion. Likewise, in some embodiments, some or all of the portions of the system 430 may be separated into two or more distinct portions.

In addition, the various portions of the system environment 400 may be maintained for and/or by the same or separate parties. It will also be understood that the system 430 may include and/or implement any embodiment of the present invention described and/or contemplated herein. For example, in some embodiments, the system 430 is configured to implement any one or more of the embodiments of the process flow 100 described and/or contemplated herein in connection with FIG. 1 or any other process flow described herein. Additionally, the system 430 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

This application incorporates by reference in their entirety each of the following applications filed concurrently herewith:

U.S. application Ser. No. ______, entitled BILL CONTROL, filed Jul. 6, 2012 to Carrie Hanson et al. (Atty. Dkt. 5163US1.014033.1650);

U.S. application Ser. No. ______, entitled ELECTRONIC PROCESSING OF PAPER INVOICES, filed Jul. 6, 2012 to Carrie Hanson et al. (Atty. Dkt. 5168US1.014033.1660);

U.S. application Ser. No. ______, entitled FINANCIAL DOCUMENT PROCESSING SYSTEM, filed Jul. 6, 2012 to Carrie Hanson et al. (Atty. Dkt. 5169US1.014033.1661);

U.S. application Ser. No. ______, entitled TRANSACTION MONITORING AND SAVINGS FEATURE, filed Jul. 6, 2012 to Carrie Hanson et al. (Atty. Dkt. 5172US1.014033.1663);

U.S. application Ser. No. ______, entitled BILL PAYMENT MANAGEMENT, filed Jul. 6, 2012 to Carrie Hanson et al. (Atty. Dkt. 5173US1.014033.1662);

U.S. application Ser. No. ______, entitled FUTURE ACCOUNT VIEW, filed Jul. 6, 2012 to Carrie Hanson et al. (Atty. Dkt. 5175US1.014033.1651); and

U.S. application Ser. No. ______, entitled CALENDAR BILL PAYMENT MANAGEMENT, filed Jul. 6, 2012 to Carrie Hanson et al. (Atty. Dkt. 5190US1.014033.1652).

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for paying a bill, the apparatus comprising:
a memory;
a processor; and
a module stored in the memory, executable by the processor, and configured to:
determine a bill due within a predetermined period in the future;
initiate, via a mobile network, notification of the bill, an amount associated with the bill, and a due date associated with the bill;
initiate, via the mobile network, a first option to pay the bill prior to the due date; and
in response to determining the first option is selected:
deduct, from an account, an amount of funds corresponding to the amount associated with the bill;
provide a reward to the account; and
transmit, on the due date, the amount of funds to a merchant associated with the bill.

2. The apparatus of claim 1, wherein in response to determining the first option is selected, the module is further configured to:
move the amount of funds to a holding account not associated with a user of the account.

3. The apparatus of claim 1, wherein in response to determining the first option is selected, the module is further configured to:
initiate presentation of information associated with the reward.

4. The apparatus of claim 1, wherein the reward is associated with a number of reward points, wherein the number of reward points is based on the amount associated with the bill and an amount of time between receiving selection of the first option and the due date associated with the bill.

5. The apparatus of claim 4, wherein a predetermined number of reward points are associated with a reward level, wherein the module is further configured to:
determine a first reward level achieved by the account based on a number of reward points achieved by the account; and
initiate presentation of a number of reward points required to achieve a second reward level higher than the first reward level achieved by the account.

6. The apparatus of claim 5, wherein the module is further configured to:
initiate pictorial representation of the first reward level achieved by the account; and
initiate pictorial representation of a number of reward points required to achieve the second reward level.

7. The apparatus of claim 1, wherein the module is further configured to:
initiate a second option to pay the bill on a due date associated with the bill, wherein an amount of funds corresponding the amount associated with the bill is deducted from the account on the due date; and
in response to determining the second option is selected, transmit, on the due date, the amount associated with the bill to a merchant associated with the bill.

8. The apparatus of claim 1, wherein the module is further configured to:
initiate a third option to dismiss the notification of the bill.

9. The apparatus of claim 8, wherein when the third option is selected, the module is further configured to:
initiate periodic notification of the bill.

10. The apparatus of claim 1, wherein the module is further configured to:
initiate presentation of an account balance associated with the account.

11. The apparatus of claim 1, wherein the module is further configured to:
initiate presentation of a duration of time between a current date and the due date.

12. The apparatus of claim 1, wherein the bill is determined based on previous bill payments made using funds associated with the account.

13. The apparatus of claim 1, wherein the bill is determined based on manual input.

14. The apparatus of claim 1, wherein the bill is determined based on an established electronic link between the account and the merchant.

15. The apparatus of claim 1, wherein the bill is at least one of a recurring or non-recurring bill.

16. The apparatus of claim 1, wherein the bill is at least one of an interest-accruing or non-interest-accruing bill.

17. The apparatus of claim 1, wherein the amount associated with the bill is at least one of automatically populated or manually input by a user.

18. The apparatus of claim 1, wherein the account comprises a financial institution account.

19. A method for paying a bill, the method comprising:
determining a bill due within a predetermined period in the future;
initiating, via a mobile network, notification of the bill, an amount associated with the bill, and a due date associated with the bill;
initiating, via the mobile network, a first option to pay the bill prior to the due date; and
in response to determining the first option is selected:
deducting, from an account, an amount of funds corresponding to the amount associated with the bill;
providing a reward to the account; and
transmitting, on the due date, the amount of funds to a merchant associated with the bill.

20. A computer program product for paying a bill, the computer program product comprising:
a non-transitory computer-readable medium comprising a set of codes for causing a computer to:
determine a bill due within a predetermined period in the future;
initiate, via a mobile network, notification of the bill, an amount associated with the bill, and a due date associated with the bill;
initiate, via the mobile network, a first option to pay the bill prior to the due date; and
in response to determining the first option is selected:
deduct, from an account, an amount of funds corresponding to the amount associated with the bill;
provide a reward to the account; and
transmit, on the due date, the amount of funds to a merchant associated with the bill.
